(19) United States
(12) Patent Application Publication
(10) Pub. No.: US 2026/0128495 A1
(43) Pub. Date: May 7, 2026

(54) SUPPORT STRUCTURE FOR ANTENNA, PREPARATION METHOD THEREOF, AND USE THEREOF

(71) Applicant: HUAWEI TECHNOLOGIES CO., LTD., Shenzhen (CN)

(72) Inventors: Ganlin Zheng, Shenzhen (CN); Changxu Zeng, Chengdu (CN); Hongyu CHEN, Shenzhen (CN)

(21) Appl. No.: 19/434,416

(22) Filed: Dec. 29, 2025

Related U.S. Application Data
(63) Continuation of application No. PCT/CN2024/095364, filed on May 25, 2024.

(30) Foreign Application Priority Data
Jun. 30, 2023 (CN) 202310801041.X

(51) Int. Cl. H01Q 1/12; H01Q 15/16

(52) U.S. Cl. CPC H01Q 1/12; H01Q 15/16

(57) ABSTRACT

A support structure for an antenna, a is connected between a feed tube and a secondary reflective surface of the antenna, and is specifically a hollow support connector. The support connector is made of a foamed material. A size shrinkage rate of the support connector is less than or equal to 1% after the support connector is placed in an environment with a temperature of 70° C. to 100° C. and relative humidity of 50% to 95% for four days. The support connector containing the foamed material is used to support the secondary reflective surface, minimizing impact of obstruction and loss on transmission of electromagnetic waves, so that excellent antenna performance can be ensured, and leading to a low hygrothermal deformation rate.

### CROSS-REFERENCE TO RELATED DISCLOSURES

This application is a continuation of International Application No. PCT/CN2024/095364, filed on May 25, 2024, which claims priority to Chinese Patent Application No.202310801041.X, filed on Jun. 30, 2023. The disclosures of the aforementioned applications are hereby incorporated by reference in their entireties.

### TECHNICAL FIELD

The disclosure relates to the field of microwave antenna technologies, and more specifically, to a support structure for an antenna, a preparation method thereof, and use thereof.

### BACKGROUND

A microwave antenna is an important part of a microwave communication system. An existing microwave antenna is usually a dual-reflective-surface microwave antenna. It offers advantages such as a short feeder length, a long equivalent focal length, and a flexible design, and usually includes a primary reflective surface, a feed, a secondary reflective surface, and a support structure configured to support the secondary reflective surface. The support structure is usually disposed directly on the primary reflective surface or a feed tube, and the support structure is usually a metal bracket. However, the metal bracket has a complex structure and is likely to obstruct transmission of electromagnetic waves, reducing antenna efficiency and affecting an antenna radiation pattern.

### SUMMARY

In view of this, embodiments of this disclosure provide a support structure for a secondary reflective surface that has small impact on performance of a microwave antenna, an antenna, and the like.

Specifically, a first aspect of embodiments of this disclosure provides a support structure for an antenna, configured to be connected between a feed tube and a secondary reflective surface of the antenna, where the support structure is a hollow support connector, and the support connector is made of a foamed material, where a size shrinkage rate of the support connector is less than or equal to 1% after the support connector is placed in an environment with a temperature of 70° C. to 100° C. and relative humidity of 50% to 95% for four days.

In an embodiment of this disclosure, the hollow support connector made of the foamed material is used to support the secondary reflective surface of the antenna, providing a simple structure, minimizing impact of obstruction and loss on transmission of electromagnetic waves, and further leading to good resistance to heat and humidity, and a small size shrinkage rate, thereby ensuring excellent near-in sidelobe performance of the antenna.

In the implementation of this disclosure, a constant Dk of the foamed material at a frequency of 6 GHz to 86 GHz is less than or equal to 1.2. Using a cell structure of the foamed material, Dk may be reduced to 1.2 or lower, which is lower than that of an unfoamed homogeneous solid material. This can ensure that the support connector has small impact of loss on transmission of electromagnetic waves, ensuring excellent antenna performance.

In the implementation of this disclosure, a dielectric loss of the foamed material at the frequency of 6 GHz to 86 GHz is less than or equal to 0.005. When Dk of the foamed material is less than or equal to 1.2, controlling the dielectric loss to be 0.005 or less can further ensure that the support connector has small impact of loss/attenuation on transmission of electromagnetic waves, ensuring more excellent antenna performance.

In the implementation of this disclosure, transmittance of the support connector with a wall thickness of 10 mm or less for a vertically incident electromagnetic wave in a frequency range of 6 GHz to 86 GHz is greater than or equal to 90%. This reflects that the support connector has good microwave transmittance. In this way, the support connector has a small microwave loss, so that antenna performance is good.

In the implementation of this disclosure, Shore hardness C of the support connector is greater than or equal to 50. This can reflect to some extent that the support connector has high mechanical strength, so that good support effect can be achieved.

In the implementation of this disclosure, in any region of at least 2 cm² on an inner surface or an outer surface of the support connector, a quantity of exposed cells is less than or equal to 20. This indicates a small quantity of cells exposed on the inner and outer surfaces of the support connector, providing excellent resistance to heat and humidity of the support connector. In some implementations of this disclosure, in any region of at least 2 cm² on an inner surface or an outer surface of the support connector, a quantity of exposed cells is less than or equal to 5.

In the implementation of this disclosure, a percentage of closed cells in the support connector is greater than or equal to 90%. A high percentage of closed cells ensures excellent resistance to heat and humidity, and high structural strength of the support connector.

In the implementation of this disclosure, a density of the support connector is 0.5 g/cm³ or less. When the support connector made of the foamed material has a low density, characteristics such as good resistance to heat and humidity and high strength can be balanced, resulting in excellent comprehensive performance. In some implementations, the density of the support connector ranges from 0.08 g/cm³ to 0.15 g/cm³.

In the implementation of this disclosure, a glass transition temperature of the support connector is greater than or equal to 150° C. This reflects that the support connector has good heat resistance, and is especially suitable for use in a high-temperature environment. In some implementations, the glass transition temperature of the support connector is greater than or equal to 190° C.

In the implementation of this disclosure, the foamed material includes a polymer with a main chain containing an aromatic structure. An aromatic polymer has good heat resistance and a low coefficient of thermal expansion, and also helps reduce size shrinkage.

In an implementation of this disclosure, the polymer includes one or more of polyimide, polyether sulfone, polyarylether, and polyarylene sulfide with the main chain containing the aromatic structure.

A second aspect of embodiments of this disclosure provides a foamed material, for a support structure for a secondary reflective surface of an antenna, where a dielectric constant of the foamed material at a frequency of 6 GHz to 86 GHz is less than or equal to 1.2.

In the implementation of this disclosure, a dielectric loss of the foamed material at the frequency of 6 GHz to 86 GHz is less than or equal to 0.005.

In the implementation of this disclosure, Shore hardness C of the foamed material is greater than or equal to 50.

In the implementation of this disclosure, a density of the foamed material is 0.5 g/cm³ or less.

A third aspect of embodiments of this disclosure provides an antenna component, where the antenna component includes a secondary reflective surface, a feed tube, and the support structure according to the first aspect of embodiments of this disclosure, where two opposite ends of the support structure are respectively connected to the feed tube and the secondary reflective surface.

A fourth aspect of embodiments of this disclosure provides an antenna, where the antenna includes a primary reflective surface and the antenna component according to the third aspect of embodiments of this disclosure, where the feed tube is connected to the primary reflective surface.

The antenna using the foregoing support structure has excellent antenna performance, a high polarization gain, a good antenna pattern, and small impact on near-in sidelobe performance of the antenna.

A fifth aspect of embodiments of this disclosure provides a communication device, where the communication device includes the antenna according to the fourth aspect of embodiments of this disclosure, an outdoor unit, and an indoor unit.

A sixth aspect of embodiments of this disclosure provides a communication system, where the communication system includes at least two communication devices according to the fifth aspect of embodiments of this disclosure, and the communication devices are capable of communicating with each other. The communication system can operate stably and efficiently.

An embodiment of this disclosure further provides a method for preparing the foregoing support structure for the antenna, including:
placing reaction raw materials for forming the support structure in a mold with a shape of a mold cavity corresponding to a shape of the support structure to be prepared, sealing the mold, and performing heat treatment, for the reaction raw materials to react and generate a gas, to obtain a hollow support connector containing a foamed material, where a size shrinkage rate of the support connector is less than or equal to 1% after the support connector is placed in an environment with a temperature of 70° C. to 100° C. and relative humidity of 50% to 95% for four days.

The foregoing preparation method is especially applicable for in-situ preparation of a support connector with high heat resistance, and makes the support connector to have a cell structure, allowing the support connector to have both good resistance to heat and humidity and low dielectricity.

An embodiment of this disclosure further provides another method for preparing the foregoing support structure for the antenna, including the following steps:
placing foamed particles in a mold with a shape of a mold cavity corresponding to a shape of the support structure to be prepared, sealing the mold, and performing hot steam treatment to fuse the foamed particles to form a foamed material, to obtain a hollow support connector, where a size shrinkage rate of the support connector is less than or equal to 1% after the support connector is placed in an environment with a temperature of 70° C. to 100° C. and relative humidity of 50% to 95% for four days.

The foregoing preparation method is also applicable for making a support connector containing a foamed material, and offers low dielectricity and good resistance to heat and humidity.

### BRIEF DESCRIPTION OF DRAWINGS

For an understanding of embodiments of the disclosure, reference is now made to the following description taken in conjunction with the accompanying drawings.

FIG. 1 is a diagram of a structure of an example of an existing microwave antenna and a support structure thereof.

FIG. 2 is a diagram of a structure of an antenna component including a support connector according to an embodiment of this disclosure, where the right panel is a cross-sectional view of the left panel.

FIG. 3 is a diagram of a structure of an antenna with the antenna component shown in FIG. 2.

FIG. 4 is a diagram of a structure of a communication device according to an embodiment of this disclosure.

FIG. 5 is a diagram of a structure of a metal bracket for an antenna according to Comparative Example 1, where the right panel is a cross-sectional view of the left panel.

FIG. 6(a), FIG. 6(b), and FIG. 6(c) summarize antenna patterns that are of an antenna in Comparative Example 1 (a), an antenna in Comparative Example 2 (b), and an antenna in Embodiment 1 (c) and that are measured in a horizontal polarization direction at a frequency of 78.5 GHz.

FIG. 7 shows an antenna pattern that is of an antenna in Embodiment 1 after a damp heat test and that is measured in a horizontal polarization direction at a frequency of 78.5 GHz.

### DESCRIPTION OF EMBODIMENTS

The following describes technical solutions in embodiments of this disclosure with reference to accompanying drawings in embodiments of this disclosure.

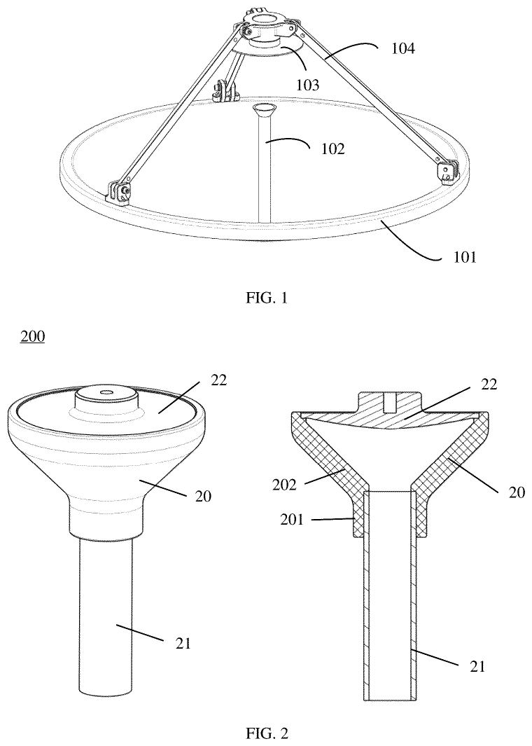

FIG. 1 is a diagram of a structure of an example of an existing microwave antenna and a support structure thereof. As shown in FIG. 1, a microwave antenna 100 includes a primary reflective surface 101, a feed tube 102 connected to the primary reflective surface 101, a secondary reflective surface 103, and a support bracket 104. The support bracket 104 is configured to support the secondary reflective surface 103 above the feed tube 102, and is connected to the primary reflective surface 101. The support bracket 104 is mostly made of a metal material, and is usually a complex structure formed by combining a plurality of parts, leading to great difficulty in processing/assembly, causing significant obstruction and loss on transmission of electromagnetic waves, consequently reducing aperture efficiency and gains of the antenna, affecting an antenna radiation pattern (which may be reflected in degradation of near-in sidelobe performance of the antenna), and the like. In some microwave antennas, a support structure is a plurality of dielectric support rods connected between a secondary reflective surface and a feed tube (for example, those described in CN105161827A). The dielectric support rod is usually of a solid structure with a dielectric constant greater than 2, and also causes obstruction and loss on transmission of electromagnetic waves, degrading antenna performance. Therefore, to resolve a problem of degradation of antenna performance caused by the support structure for the secondary reflective surface that is used by the existing microwave antenna, embodiments of this disclosure provide a support structure for a secondary reflective surface that does not degrade microwave antenna performance.

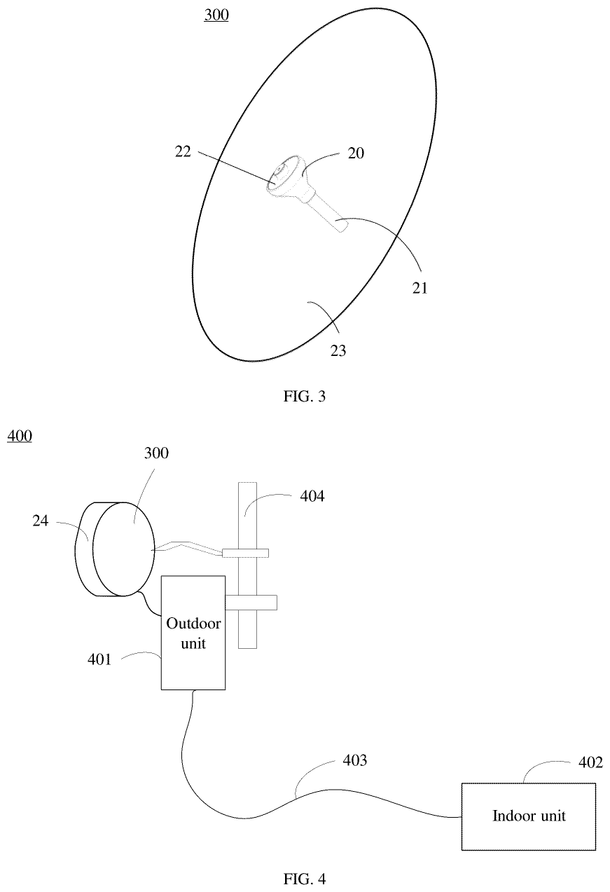

FIG. 2 shows an antenna component and a cross-sectional view thereof including a support structure according to an embodiment of this disclosure. An antenna component 200 includes a feed tube 21, a secondary reflective surface 22, and a support structure 20, where two opposite ends of the support structure 20 are respectively connected to the feed tube 21 and the secondary reflective surface 22. The support structure 20 is connected between the feed tube 21 and the secondary reflective surface 22 of an antenna. The support structure 20 is a hollow support connector 20. The support connector 20 is made of a foamed material. A size shrinkage rate of the support connector 20 is less than or equal to 1% after the support connector 20 is placed in an environment with a temperature of 70° C. to 100° C. and relative humidity of 50% to 95% for four days.

The support structure for the secondary reflective surface of the antenna is changed from a common complex support bracket to a hollow support connector. The support connector causes minimal obstruction and loss on transmission of electromagnetic waves, and is a single part without assembly. In this way, design, processing, and assembly of the support structure can be simplified, a basic support function is ensured, and a separate design of a sealing structure for the feed tube, as required by the support bracket, is not required to protect a feed disposed on the feed tube. After the support connector 20 is connected to the feed tube 21 and the secondary reflective surface 22, the feed tube 21 can be sealed and dustproofed. More importantly, the support connector is made of the foamed material with a cell structure. Using the appropriate cell structure, when the foamed material has low Dk, resistance to heat and humidity of the foamed material is not significantly reduced. Therefore, the support connector exhibits minimal shrinkage and deformation under high-temperature and high-humidity conditions. This does not affect reliability of a connection between the support connector and the feed tube 21 and a connection between the support connector and the secondary reflective surface 22, and minimizes impact on an antenna polarization gain and an antenna pattern.

Therefore, the support connector made of the foamed material provided in an embodiment of this disclosure is used to support the secondary reflective surface, providing a simple structure and a low dielectric constant, minimizing impact of obstruction and loss on transmission of electromagnetic waves, ensuring excellent antenna performance, and providing good resistance to heat and humidity, thereby ensuring a long-term stable support/connection function of the support connector on the antenna.

In the implementation of this disclosure, the size shrinkage rate of the support connector 20 is less than or equal to 1%, for example, less than or equal to 0.8%, less than or equal to 0.5%, or less than or equal to 0.3%, after the support connector 20 is placed in an environment with a temperature of 70° C. to 100° C. and relative humidity of 50% to 95% for one week (that is, seven days). In some embodiments, the size shrinkage rate of the support connector 20 is less than or equal to 1% after the support connector 20 is placed in an environment with a temperature of 85° C. and relative humidity of 95% for four days, and is still less than or equal to 1% after one week.

In the implementation of this disclosure, a dielectric constant Dk of the foamed material at a frequency of 6 GHz to 86 GHz is less than or equal to 1.2. Using appropriate cell structure of the foamed material, the dielectric constant Dk at the frequency of 6 GHz to 86 GHz may be reduced to 1.2 or lower, which is lower than that of an unfoamed homogeneous solid material. In this way, the support structure in an embodiment of this disclosure has small impact of loss on transmission of electromagnetic waves, and has small impact of degradation on antenna performance.

In the implementation of this disclosure, a dielectric loss Df of the foamed material at the frequency of 6 GHz to 86 GHz is less than or equal to 0.005. A lower end (that is, an end close to the feed tube 21) of the support connector 20 usually has a short distance from the secondary reflective surface 22, and the low Dk of the foamed material helps reduce obstruction/loss on transmission of electromagnetic waves caused by the support connector 20. Based on this, controlling Df to be 0.005 or less can further ensure that the support connector 20 has small impact of loss/attenuation on transmission of electromagnetic waves, ensuring more excellent antenna performance. In an embodiment, Df may be less than or equal to 0.004, further less than or equal to 0.003, less than or equal to 0.002, less than or equal to 0.001, or the like.

The foregoing Dk and Df may be measured on a sample of the foamed material according to a resonant cavity method. In an embodiment, a grid analyzer may be used for testing, and a fixture with a resonant cavity is used. The frequency 6 GHz to 86 GHz is a common frequency range corresponding to microwaves. Common microwave bands include a band of 6 GHz to 42 GHZ, a band of 57 GHz to 64 GHZ, and a band of 71 GHz to 86 GHz. In this disclosure, the dielectric constant Dk of the foamed material at a frequency of 6 GHz to 42 GHz is less than or equal to 1.2; the dielectric constant Dk of the foamed material at a frequency of 57 GHz to 64 GHz is less than or equal to 1.2; and the dielectric constant Dk of the foamed material at a frequency of 71 GHz to 86 GHz is less than or equal to 1.2. For values of Dk in each band, refer to the foregoing description. Similarly, the dielectric loss Df of the foamed material at a frequency of 6 GHz to 42 GHz is less than or equal to 0.005; the dielectric loss Df of the foamed material at a frequency of 57 GHz to 64 GHz is less than or equal to 0.005; and the dielectric loss Df of the foamed material at 71 GHz to 86 GHz is less than or equal to 0.005. For values of Df in each band, refer to the foregoing description.

In the implementation of this disclosure, transmittance of the support connector 20 with a wall thickness of 10 mm or less for a vertically incident electromagnetic wave in a frequency range of 6 GHz to 86 GHz is 90% or more (that is, greater than or equal to 90%). The transmittance may be measured according to a method recorded in the following literature: Journal of Sichuan Ordnance, Vol. 32, No. 4, “Dielectricity of Wave-Transmitting Dielectric Material, and Test Method”. Transmittance of 90% or more can reflect that the foamed material used by the support connector 20 has good microwave transmittance. In this way, a loss generated when the microwave passes through the support connector 20 is small, thereby ensuring good performance of the antenna using the support structure. In some implementations, the transmittance is 92% or more, and may be further 95% or more, such as 95.5%, 96%, 96.5%, 97%, 98%, or 99%. Electromagnetic waves in the range of 6 GHz to 86 GHz are usually microwaves. As described above, common microwave bands include a band of 6 GHz to 42 GHZ, a band of 57 GHz to 64 GHZ, and a band of 71 GHz to 86 GHZ. Transmittance of the support connector 20 with a wall thickness of 10 mm or less for a vertically incident microwave at a frequency of 6 GHz to 42 GHZ, a frequency of 57 GHz to 64 GHz, or a frequency of 71 GHz to 86 GHz is 90% or more. For values of the transmittance in each band range, refer to the description in this paragraph.

In the implementation of this disclosure, Shore hardness C of the support connector 20 is greater than or equal to 50. This can reflect to some extent that the support connector 20 has high mechanical strength, so that good support effect can be achieved. The support connector 20 does not undergo significant deformation under load or collapse upon collision, so that the secondary reflective surface 22 and the like supported by the support connector 20 do not move significantly. In some implementations, Shore hardness C of the support connector 20 is greater than or equal to 70.

In an implementation of this disclosure, in any region of at least 2 cm² on an inner surface or an outer surface of the support connector 20, a quantity of exposed cells is less than or equal to 20. This indicates a small quantity of cells exposed on the inner and outer surfaces of the support connector 20, allowing for excellent resistance to water absorption and high structure/shape stability of the support connector 20, for example, ensuring that the size shrinkage rate is 1% or less after the support connector 20 is placed under high-humidity and high-temperature conditions for four days. In an embodiment, the quantity of the exposed cells is less than or equal to 15, less than or equal to 10, less than or equal to 8, or the like. In some implementations of this disclosure, in any region of at least 2 cm² on the inner surface or the outer surface of the support connector 20, the quantity of exposed cells is less than or equal to 5. Further, there is no cell exposed on the inner surface and the outer surface of the support connector 20. In this case, the support connector 20 has more excellent resistance to heat and humidity.

In the implementation of this disclosure, a percentage of closed cells in the support connector 20 is greater than or equal to 90%, such as 92% or more, 95% or more, 96% or more, 97% or more, 98% or more, or 99% or more. A high percentage of closed cells indicates that most of cells in the support connector 20 are closed, ensuring excellent resistance to heat and humidity, and high structural strength of the foamed material. The percentage of closed cells of the foamed material may be measured according to the standard GB/T 10799-2008. In some implementations, the cells in the support connector 20 are closed, in other words, the percentage of closed cells is 100%.

In this disclosure, the support connector 20 is made of a foamed material with fewer cells on the surface, more cells inside, and a high percentage of closed cells. These structural features allow Dk of the foamed material to be 1.2 or less, and the size shrinkage rate to be still 1% or less after the foamed material is placed under high-temperature and high-humidity conditions for one week.

In the implementation of this disclosure, a density of the support connector 20 is 0.5 g/cm³ or less. The apparent density of the support connector may be measured according to the standard GB/T6343-2009. A low density of the support connector made of the foamed material ensures lightweight of the component shown in FIG. 2 using the support connector, and balances characteristics such as good resistance to heat and humidity and high strength. In some implementations of this disclosure, the density of the support connector 20 is 0.4 g/cm³ or less, or 0.3 g/cm³ or less, or 0.2 g/cm³ or less. In some embodiments, the density of the support connector 20 ranges from 0.08 g/cm³ to 0.15 g/cm³, for example, 0.09 g/cm³, 0.10 g/cm³, 0.12 g/cm³, 0.13 g/cm³, 0.14 g/cm³, or 0.145 g/cm³. In this case, the support connector 20 can achieve great support effect, and better balance low dielectricity, good resistance to heat and humidity, and the like.

In the implementation of this disclosure, a glass transition temperature Tg of the support connector 20 is greater than or equal to 150° C. High Tg reflects that the support connector has good heat resistance, and its thermal decomposition temperature and cell collapse temperature are also 150° C. or higher, making the support connector particularly suitable for use in a high-temperature environment. In addition, high Tg can further reflect to some extent high rigidity and good mechanical performance. Usually, limited by a foaming process (for example, a supercritical foaming method), Tg of a conventional organic foamed material rarely exceeds 150° C., and an organic dielectric material with high Tg (for example, thermosetting polyimide) is hardly transformed into a foamed material with a cell structure. The foamed material that is used by the support connector 20 in this disclosure and that is prepared according to the following preparation method in embodiments of this disclosure can well balance these two contradiction points. In an embodiment, Tg of the support connector 20 may be 150° C., 160° C., 180° C., 190° C., 195° C., 200° C., 220° C., or higher. In some implementations, the glass transition temperature of the support connector 20 is greater than or equal to 190° C., further greater than or equal to 200° C., for example, 200° C. to 450° C. In this case, the support connector has better heat resistance.

In the implementation of this disclosure, the foamed material includes a polymer with a main chain containing an aromatic structure. The rigid aromatic structure contained in the molecular main chain of the polymer helps improve heat resistance of the polymer, and reduce a coefficient of thermal expansion (CTE for short) of the polymer, and also helps reduce size shrinkage under high-temperature and high-humidity conditions. The polymer includes, but is not limited to, one or more of polyimide with the main chain containing the aromatic structure, polyether sulfone with the main chain containing the aromatic structure, polyarylether (for example, polyphenylene oxide PPO), and polyarylene sulfide (for example, polyphenylene sulfide PPS).

In some implementations of this disclosure, the polymer is a polymer that can generate a reaction gas in a preparation process of the polymer, for example, polyimide with the main chain containing the aromatic structure. In this way, the support connector that meets the requirements such as low dielectricity and resistance to heat and humidity and that has high thermal stability can be prepared according to the following preparation method provided in embodiments of this disclosure. The foamed material containing polyimide can be prepared through an in-situ reaction between dianhydride or polyacid and polyisocyanate. The dianhydride or polyacid contains an aromatic ring, or the polyisocyanate contains an aromatic ring, or the dianhydride or polyacid contains an aromatic ring and the polyisocyanate contains an aromatic ring.

In this disclosure, the support connector 20 is made of the foamed material. Therefore, equivalent replacement may be performed between the foregoing descriptions about characteristics (such as Tg, hardness, and density) of the support connector 20 and the foamed material in this disclosure. For example, Tg of the support connector 20 is the glass transition temperature of the foamed material.

In this disclosure, in an implementation of this disclosure, the support connector 20 is of a hollow structure, to facilitate sleeving on the feed tube. An opening size of the support connector 20 increases in a gradient from one end to the other end. In an embodiment, the opening size of the support connector 20 increases in a gradient in a direction from the feed tube 21 to the secondary reflective surface 22. It may be understood that an opening size at an end that is of the support connector 20 and that is close to the feed tube 21 is greater than an opening size at an end that is of the support connector 20 and that is close to the secondary reflective surface 22. In this way, a connection between the feed tube with a small diameter and the secondary reflective surface 22 with a large lateral dimension can be implemented.

A way to “increase in a gradient” may include: a gradual increase, or remaining unchanged followed by a gradual increase, or remaining unchanged, then increasing, then remaining unchanged, and then increasing, or the like. In some embodiments, “increase in a gradient” is remaining unchanged followed by a gradual increase. As shown in FIG. 2, the support connector 20 includes a first main body portion 201 and a second main body portion 202, where the first main body portion 201 is close to the feed tube 21, and the second main body portion 202 is close to the secondary reflective surface 22. An opening size of the first main body portion 201 is unchanged, and an opening size of the second main body portion 202 gradually increases in a direction toward the secondary reflective surface 22. In this way, it can be ensured that the support connector 20 is securely connected to the feed tube 21 and the secondary reflective surface 22. To improve connection stability, an end surface on which the support connector 20 and the secondary reflective surface 22 are connected may have a shape that matches a shape of an end surface of the secondary reflective surface 22, and an end surface on which the support connector 20 and the feed tube 21 are connected may have a shape that matches a shape of an end surface of the feed tube 21.

In the implementation of this disclosure, a side surface of the support connector 20 is a smooth curved surface. The “side surface” is a surface for shaping the support connector, that is, an outer surface excluding a surface perpendicular to a length direction of the feed tube 21. In this disclosure, the side surface of the support connector 20 is smooth and not stepped. In this way, when the opening size of the support connector 20 changes, the entire support connector does not interfere with transmission of electromagnetic waves due to excessive edges or corners. In some embodiments, the support connector 20 is of a hollow circular truncated cone structure, and the side surface of the support connector 20 is a side surface in a circular truncated cone shape.

In some implementations of this disclosure, the side surface of the support connector 20 is symmetric about a central axis of the feed tube 21. This allows parameters to be set to only one side of the support connector, and the other side adopts the same parameters, so that difficulty in process design and manufacturing can be reduced.

In an implementation of this disclosure, a wall thickness of the support connector 20 may be in a range of 7 mm to 15 mm, for example, 7.5 mm, 8 mm, 8.5 mm, 9 mm, 9.5 mm, 10 mm, 11 mm, 12 mm, 13 mm, or 14 mm. Controlling the thickness of the support connector to be in an appropriate range can ensure sufficient strength to implement a physical support function, and can avoid impact on an antenna gain caused by loss of electromagnetic waves incident onto the support connector due to excessive thickness.

An embodiment of this disclosure further provides a method for preparing the foregoing support structure.

In an embodiment, in some implementations, the preparation method may include the following steps:
placing reaction raw materials for forming the support structure in a mold with a shape of a mold cavity corresponding to a shape of the support structure to be prepared, sealing the mold, and performing heat treatment, for the reaction raw materials to react and generate a gas, to obtain a hollow support connector containing a foamed material, that is, to obtain the support structure, where a size shrinkage rate of the support connector is less than or equal to 1% after the support connector is placed in an environment with a temperature of 70° C. to 100° C. and relative humidity of 50% to 95% for four days.

In an embodiment of this disclosure, the reaction raw material is also a raw material required for forming the foamed material, and there are usually two or more reaction raw materials. A temperature for the heat treatment should be an initial temperature at which the reaction raw materials react or higher. The gas generated through the reaction between the reaction raw materials acts as a pore-forming agent. The foamed material can be prepared in situ by using the sealed mold, with almost no exposed cell at a position in contact with a mold cavity wall of the mold, and with a shape required by the foamed material, that is, the hollow support connector is obtained. In this way, additional CNC (computer numerical control, computer numerical control) machining on the support connector can be greatly reduced, avoiding exposed cells all over a surface of the support connector, thereby ensuring that the size shrinkage rate of the support connector is 1% or less after the support connector is placed under the foregoing high-temperature and high-humidity conditions for four days.

It should be noted that, limited by a conventional foaming process, a raw material with high heat resistance (for example, an aromatic polymer with Tg of 150° C. or higher, or even with Tg of 190° C. or higher) is hardly transformed into a foamed material with a cell structure according to a conventional foaming method such as a supercritical foaming method or a physical foaming method using foaming microspheres. When the raw material is a thermosetting raw material, the raw material is more hardly transformed into a foamed material. However, the foregoing preparation method provided in this embodiment of this disclosure is particularly suitable for preparing a foamed material with high heat resistance (for example, particularly suitable for a foamed material with Tg of 190° C. or higher), and provides good resistance to heat and humidity, and low dielectricity.

In this disclosure, the parameters including types of the reaction raw materials and a molar ratio between the reaction raw materials are controlled, so that the size shrinkage rate of the support connector can be less than or equal to 1% after the support connector is placed in an environment with a temperature of 70° C. to 100° C. and relative humidity of 50% to 95% for four days, and the dielectric constant of the foamed material at a frequency of 6 GHz to 86 GHz can be less than or equal to 1.2. When a volume of the mold cavity and types of the reaction raw materials are fixed, an amount of the gas generated through the reaction can be adjusted by adjusting a molar ratio between the reaction raw materials, to adjust a gas pressure environment in the sealed mold, and a foaming ratio and a cell structure of the foamed material are controlled to be appropriate, to adjust the dielectric constant Dk to be 1.2 or less. In addition, the type of each reaction raw material affects quality of the foamed material, and correspondingly affects dielectricity of the foamed material and the size shrinkage rate under hygrothermal conditions.

In some implementations, the reaction raw materials react to form a polymer, and the foamed material is an organic foamed material containing the polymer. In some specific embodiments, the polymer is polyimide with a main chain containing an aromatic structure. Correspondingly, the reaction raw materials include dianhydride or polyacid, polyisocyanate, a catalyst, and the like. If the polymer is prepared through a reaction between dianhydride and polyisocyanate, at least one of dianhydride and polyisocyanate contains an aromatic ring. For example, the reaction raw materials are aromatic dianhydride and aromatic polyisocyanate, or aromatic dianhydride and aliphatic polyisocyanate, or the like.

In some implementations of this disclosure, the reaction raw materials may further include one or more of a cell stabilizer, an auxiliary foaming agent, and the like. The cell stabilizer can be used to stabilize a gas generated in a process of forming the polymer, to ensure formation of a cell structure. The cell stabilizer is usually a surfactant. The auxiliary foaming agent may be a solvent with a low boiling point, for example, one or more of furfuryl alcohol and formic acid, and also helps cell formation during volatilization.

In some other implementations, a method for preparing the foregoing support structure may include the following steps:
placing foamed particles in a mold with a shape of a mold cavity corresponding to a shape of the support structure to be prepared, sealing the mold, and performing hot steam treatment to fuse the foamed particles to form a foamed material, to obtain a hollow support connector, where a size shrinkage rate of the support connector is less than or equal to 1% after the support connector is placed in an environment with a temperature of 70° C. to 100° C. and relative humidity of 50% to 98% for four days.

In an embodiment of this disclosure, the foamed particles with a cell structure are injected into the mold cavity of the sealed mold, and subjected to hot steam treatment, so that surfaces of the foamed particles can be fused together under the effect of the hot steam, to obtain a “fused substance” with a specific configuration, which is the foamed material, that is, to obtain the hollow support connector. The hot steam treatment allows the foamed particles to be fused together, and further facilitates expansion of the foamed particles that are fused together, to obtain a foamed material with an appropriate cell structure and an appropriate foaming ratio, so that a dielectric constant of the foamed material is low. In addition, the hot steam treatment is further conducive to releasing internal stress of the foamed particles and mitigating defects, thereby helping reduce subsequent size shrinkage of the foamed material. Moreover, the configuration of the foamed material is the shape of the support structure. The use of the sealed mold can ensure fewer cells exposed on the inner and outer surfaces of the support connector, and can also reduce additional CNC machining on the prepared support connector as described in the foregoing method, avoiding exposed cells all over the surface of the support connector, thereby ensuring that the size shrinkage rate of the support connector is 1% or less after the support connector is placed under the foregoing high-humidity and high-temperature conditions for four days.

Therefore, the foregoing preparation method provided in embodiments of this disclosure is also applicable for making a support structure containing a foamed material, and offers low dielectricity and good resistance to heat and humidity. In particular, the preparation method is more applicable for making a foamed material with a glass transition temperature of 150° C. or higher. In an implementation of this disclosure, the dielectric constant Dk of the foamed material at the frequency of 6 GHz to 86 GHz may be reduced to be 1.2 or less.

The hot steam may be water vapor or flue gas, but is not limited thereto. The foamed particles contain a material corresponding to the support structure. For example, when the foamed material contains a polymer, the foamed particles also contain the polymer. The material of the foamed particles also affects the dielectric constant of the foamed material. Therefore, the dielectric constant of the foamed material can also be adjusted by controlling parameters including the material of the foamed particles. To facilitate fusion of the foamed particles and reduction of a temperature of the hot steam, the surface of the foamed particles may be treated, for example, coated with a fusing agent (for example, polystyrene) that can reduce a softening temperature of the foamed particles.

In addition, a particle size of the foamed particles can also affect porosity of fused particles and a dielectric loss of the foamed material. To reduce the dielectric loss, in an implementation of this disclosure, the particle size of the used foamed particles is controlled to be 1 mm or less.

An embodiment of this disclosure further provides a foamed material, for a support structure for a secondary reflective surface of an antenna, where a dielectric constant of the foamed material at a frequency of 6 GHz to 86 GHz is less than or equal to 1.2. In other words, this disclosure provides use of a foamed material in a support structure for a secondary reflective surface of an antenna.

The foamed material with a cell structure is used for the support structure for the secondary reflective surface of the antenna. With the help of the appropriate cell structure, the dielectric constant Dk of the foamed material at the frequency of 6 GHz to 86 GHz may be reduced to 1.2 or lower, which is lower than that of an unfoamed homogeneous solid material. In this way, the support structure has small impact of degradation on electrical performance of the antenna, and has small impact of loss on transmission of electromagnetic waves (microwaves).

The foamed material with the cell structure provided in this disclosure ensures that Dk is low, mechanical hardness and density are not reduced significantly and can meet support requirements, and resistance to heat and humidity is good. As described above in this disclosure, the support connector 20 is made of the foamed material. Therefore, the descriptions about characteristics of the support connector 20 in this disclosure are also applicable to the foamed material. In an embodiment, in an implementation of this disclosure, Shore hardness C of the foamed material is greater than or equal to 50. A density of the foamed material is 0.5 g/cm³ or less, and further ranges from 0.08 g/cm³ to 0.15 g/cm³. A dielectric loss Df of the foamed material at the frequency of 6 GHz to 86 GHz is less than or equal to 0.005. A glass transition temperature of the foamed material is greater than or equal to 150° C., and is further greater than or equal to 190° C. In any region of at least 2 cm² on a surface of the foamed material, a quantity of exposed cells is less than or equal to 20, and is further less than or equal to 5. A percentage of closed cells in the foamed material is greater than or equal to 90%. These ensure good resistance to heat and humidity of the foamed material. For specific values of the parameters, further narrowed ranges, and the like, refer to the foregoing descriptions of this disclosure.

An embodiment of this disclosure further provides an antenna. The antenna includes the antenna component 200 including the foregoing support structure in embodiments of this disclosure.

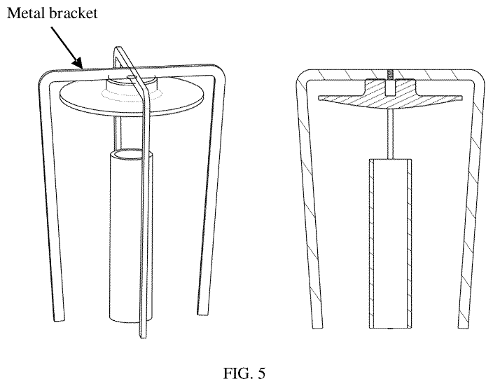

Referring to FIG. 3, a diagram of a structure of an antenna according to an embodiment of this disclosure is illustrated. The antenna in FIG. 3 includes the antenna component shown in FIG. 2. An antenna 300 includes a primary reflective surface 23, a secondary reflective surface 22, a feed tube 21, and a support structure 20 (that is, the support connector 20), where the feed tube 21 is connected to the primary reflective surface 23, and two opposite ends of the support structure 20 are respectively connected to the feed tube 21 and the secondary reflective surface 22. In this way, the support connector 20 is disposed between the feed tube 21 and the secondary reflective surface 22, and connects the feed tube 21 and the secondary reflective surface 22 to be fixed on a same central axis. In some embodiments, the structure shown in FIG. 2 includes the secondary reflective surface 22, the support connector 20, and the feed tube 21 that are sequentially connected from top to bottom and that have a same central axis. The antenna shown in FIG. 3 is usually configured to receive/transmit an electromagnetic wave in a microwave band. Therefore, the antenna may be referred to as a “microwave antenna”, and may be further referred to as a “dual-reflective-surface microwave antenna” or a Cassegrain antenna.

In some implementations of this disclosure, one end of the support connector 20 is sleeved on an outer side of the feed tube 21, and the other end is connected to the secondary reflective surface 22. In this way, an end of the feed tube 21 is located in space enclosed by the support connector 20, the feed tube 21, and the secondary reflective surface 22, so that a feed on the feed tube 21 can be sealed and dustproof. A manner of sleeving the support connector 20 on the outer side of the feed tube 21 may be a threaded connection, bonding, or the like.

In some implementations of this disclosure, the two opposite ends of the support connector 20 are respectively bonded to the feed tube 21 and the secondary reflective surface 22. Compared with the threaded connection, the bonding manner eliminates the need for machining threads on the inner surface of the support connector 20, reducing difficulty in making the support connector 20, and ensuring a small quantity of cells exposed on the surface of the support connector 20.

In this disclosure, the antenna 300 may further include a feed (not shown in FIG. 2 and FIG. 3), and the feed is disposed at an end that is of the feed tube 21 and that is close to the secondary reflective surface 22. The feed is a primary radiator of a reflective-surface microwave antenna, and has a function of converting a radio frequency signal in a feeder into a spatial electromagnetic wave and radiating the spatial electromagnetic wave onto the secondary reflective surface 22. The feed may be a horn feed, a dipole feed, a dual-slot feed, or the like. A Cassegrain antenna usually uses a horn feed.

When the antenna transmits a signal, the feed may be configured to generate an electromagnetic wave, the secondary reflective surface 22 may be configured to reflect the electromagnetic wave generated by the feed to the primary reflective surface 23, and the primary reflective surface 23 may further reflect the electromagnetic wave reflected by the secondary reflective surface 22, to complete a signal radiation function of the antenna 300. When the antenna receives a signal, the signal is reflected by the primary reflective surface 23 to the secondary reflective surface 22 and finally enters the feed, and is then transmitted by the feed tube to a rear-end receiving system of the antenna.

In this disclosure, the primary reflective surface 23 and the secondary reflective surface 22 are usually made of a metal material, for example, aluminum. The primary reflective surface 23 is usually a paraboloid of revolution. In an implementation of this disclosure, a base (not shown in FIG. 3) may be further disposed at a tail (that is, an end away from the secondary reflective surface 22) of the feed tube 21, and the feed tube 21 can be mounted on the primary reflective surface 23 by using the base.

In addition, the antenna 300 may further include a radome (not shown in FIG. 3) that is usually disposed on the primary reflective surface 23, to cover the feed tube 21, the support structure 20, and the secondary reflective surface 22 in space enclosed by the radome and the primary reflective surface 23. The radome is configured to protect the feed tube 21, the support structure 20, and the secondary reflective surface 22 from interference caused by harsh outdoor weather.

An embodiment of this disclosure further provides a communication device. The communication device includes the foregoing antenna in embodiments of this disclosure.

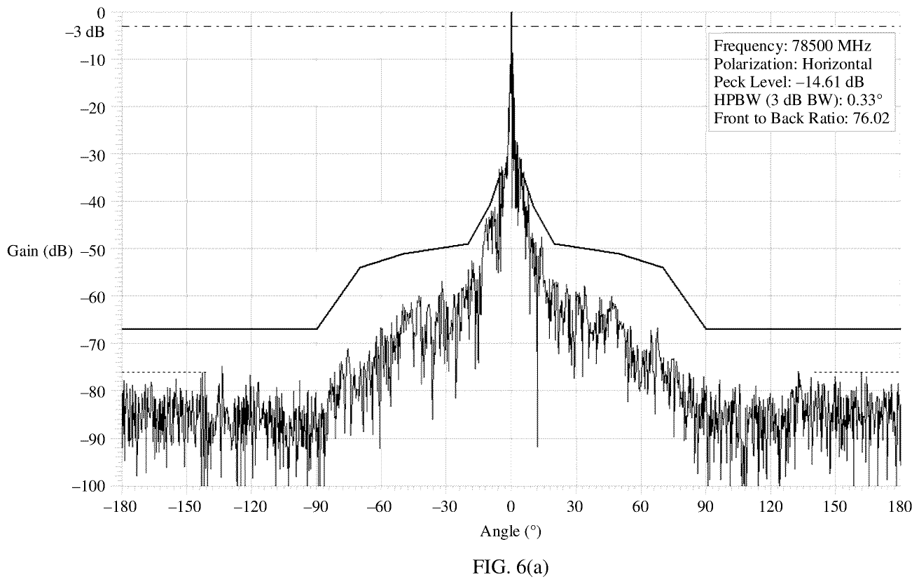

FIG. 4 shows a structure of an example of a communication device according to an embodiment of this disclosure. As shown in FIG. 4, a communication device 400 includes the antenna 300 (FIG. 4 shows an antenna with a radome), an outdoor unit (Out Door Unit, ODU) 401, and an indoor unit (Indoor Unit, IDU) 402. The outdoor unit 401 is connected to the antenna 300, and the indoor unit 402 and the outdoor unit 401 may be connected by an intermediate frequency cable 403.

The outdoor unit 401 may be connected to the antenna 300 directly or by a flexible waveguide. This helps reduce feeder loss. The antenna 300 may be mounted on a pole 404 or a tower by adjusting a bracket, to facilitate reception or transmission of antenna signals.

The antenna 300 shown in FIG. 4 further includes a radome 24 that is disposed on the primary reflective surface 23 of the antenna, to cover the feed tube 21, the support structure 20, and the secondary reflective surface 22 in space enclosed by the radome 24 and the primary reflective surface 23. In this way, the feed tube 21, the support structure 20, and the secondary reflective surface 22 are all located on an inner side of the primary reflective surface 23. The radome 24 has a good electromagnetic-wave penetration characteristic for electrical performance, and can withstand impact of an external harsh environment for mechanical performance, thereby protecting a core component of the antenna from impact of an external environment.

In an embodiment, the indoor unit 402 may be configured to process a baseband signal and convert the baseband signal into an intermediate-frequency signal, and transmit the intermediate-frequency signal to the outdoor unit 401; the outdoor unit 401 can implement frequency conversion and amplification of the intermediate-frequency signal and a radio frequency signal, and transmit the processed radio frequency signal to the antenna 300; and the antenna 300 is configured to convert the radio frequency signal into a spatial electromagnetic wave and radiate the spatial electromagnetic wave. A process in which the antenna receives a radio frequency signal operates in reverse. The outdoor unit 401 can perform frequency selection, amplification, and frequency conversion on the radio frequency signal received by the antenna, convert the radio frequency signal into an intermediate-frequency signal, and send the intermediate-frequency signal to the indoor unit 402; and then the indoor unit 402 processes and converts the intermediate-frequency signal into a baseband signal.

In an implementation of this disclosure, the communication device may be a device for communication in a microwave band, that is, a microwave device. A communication band of the microwave device is in a range of 6 GHz to 86 GHz. In some implementations, the communication band of the microwave device includes a band of 6 GHz to 42 GHZ, a band of 57 GHz to 64 GHZ, and a band of 71 GHz to 86 GHz.

An embodiment of this disclosure further provides a communication system. The communication system includes at least two communication devices as described above, and the communication devices are capable of communicating with each other. As described above, the communication device may be a microwave device with a communication band in a range of 6 GHz to 86 GHz.

The following further describes embodiments of this disclosure by using a plurality of specific embodiments. Embodiments of this disclosure are not limited to the following specific embodiments.

In an exemplary embodiment, a support structure for a secondary reflective surface of a microwave antenna is provided and is configured to be connected between a feed tube and the secondary reflective surface of the antenna. The support structure is a hollow support connector (as shown by the reference numeral 20 in FIG. 2). One end is sleeved on an outer side of the feed tube and is bonded to the feed tube, and the other end is bonded to the secondary reflective surface. A wall thickness of the support connector is about 8 mm.

The support connector is made of a foamed material. The foamed material contains polyimide (PI) with a main chain containing an aromatic structure. A dielectric constant Dk of the foamed material at a frequency of 6 GHz to 86 GHz is about 1.17 to 1.18. A size shrinkage rate of the support connector is 0.2% after the support connector is placed in an environment with a temperature of 85° C. and relative humidity of 85% for one week.

There is no cell exposed on an inner surface and an outer surface of the support connector. A percentage of closed cells in the support connector is 97% or more. The support connector has a density of 0.128 g/cm³ and Shore hardness C of about 70. A glass transition temperature Tg of the support connector is 315° C. A coefficient of thermal expansion CTE of the PI is 48 ppm/° C. A dielectric loss Df of the foamed material at a frequency of 6 GHz to 86 GHz is about 0.004. Transmittance of the support connector with the wall thickness of 8 mm for a vertically incident electromagnetic wave in a frequency range of 6 GHz to 86 GHz is 90%.

The foamed material is formed through a reaction of aromatic dianhydride (pyromellitic dianhydride) and aromatic isocyanate (polymethylene polyphenyl isocyanate) in a molar ratio of 0.9:1, a catalyst (a composite catalyst formed by triethanolamine and dibutyltin dilaurate), a foaming additive anhydrous methanol, and a cell stabilizer in a sealed mold under heating conditions. In an embodiment, the aromatic dianhydride and the aromatic isocyanate react in situ to form PI, and a cell structure is obtained with the help of CO₂ generated through the reaction. In addition, a small amount of water may be added to adjust a reaction rate and a quantity of generated cells. A foaming ratio of the foamed material is 7 (the foaming ratio is a ratio of a volume of the foamed material to a volume of reaction raw materials for forming PI).

In an exemplary embodiment, a support structure for a secondary reflective surface of a microwave antenna is provided and is configured to be connected between a feed tube and the secondary reflective surface of the antenna. The support structure is a hollow support connector (as shown by the reference numeral 20 in FIG. 2). One end is sleeved on an outer side of the feed tube and is bonded to the feed tube, and the other end is bonded to the secondary reflective surface. A wall thickness of the support connector is about 8 mm.

The support connector is made of a foamed material. The foamed material contains polyphenylene oxide (PPO) with a main chain containing an aromatic structure. A dielectric constant Dk of the foamed material at a frequency of 6 GHz to 86 GHz is about 1.15 to 1.16. A size shrinkage rate of the support connector is 0.3% after the support connector is placed in an environment with a temperature of 85° C. and relative humidity of 85% for one week.

There is no cell exposed on an inner surface and an outer surface of the support connector. A percentage of closed cells in the support connector is 100%. The support connector has a density of 0.135 g/cm³ and Shore hardness C of about 78. A glass transition temperature Tg of the support connector is 211° C. A coefficient of thermal expansion CTE of the PPO is 60 ppm/° C. A dielectric loss Df of the foamed material at a frequency of 6 GHz to 86 GHz is about 0.001 to 0.003. Transmittance of the support connector with the wall thickness of 8 mm for a vertically incident electromagnetic wave in a frequency range of 6 GHz to 86 GHz is 90%.

A process of preparing the support connector may include the following steps: Supercritical foaming is performed on surface-modified polyphenylene oxide (PPO) plastic particles (the surface is coated with a low-melting-point polymer (for example, polystyrene)) in an extruder with nitrogen or carbon dioxide at a glass transition temperature of the plastic particles or higher, to obtain foamed particles with a predetermined foaming ratio. Then, the foamed particles are injected into a mold cavity, and high-temperature water vapor is introduced into the mold cavity, for the foamed particles to be fused to form the foamed material, to obtain the hollow support connector.

To highlight effects of embodiments of this disclosure, Comparative Example 1 and Comparative Example 2 are provided below.

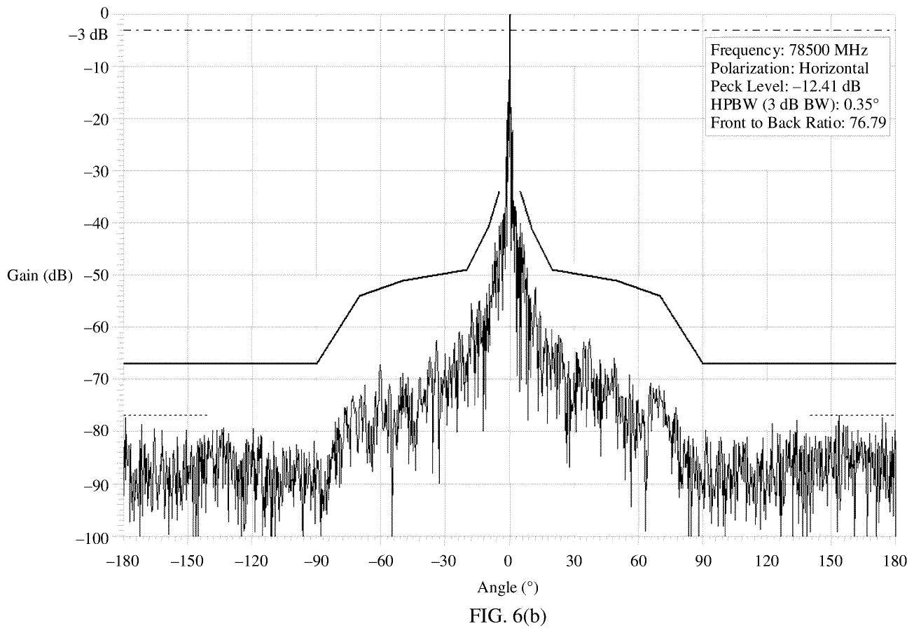

In a comparative Example 1, a support structure for a microwave antenna is provided and is configured to be connected to a primary reflective surface of the antenna, to support a secondary reflective surface. The support structure is a metal bracket (with a structure is shown in FIG. 5).

In a comparative Example 2, a support structure for a secondary reflective surface of a microwave antenna is provided and is a hollow support connector, with a structure same as that in Embodiment 1. A difference lies in that the support connector is made by using a foamed plate containing a mixture of polyphenylene oxide (PPO) and polystyrene (PS) according to a machining method. A dielectric constant Dk of the foamed material at a frequency of 6 GHz to 86 GHz is about 1.15 to 1.16. However, a size shrinkage rate of the support connector is 3% after the support connector is placed in an environment with a temperature of 85° C. and relative humidity of 85% for one week, failing to possess hygrothermal aging resistance.

To further demonstrate beneficial effects of this disclosure, the support structures in Embodiment 1, Comparative Example 1, and Comparative Example 2 are respectively assembled into dual-reflective-surface microwave antennas, and polarization gains and patterns of the antennas are measured.

Table 1 below summarizes vertical polarization gains and horizontal polarization gains of the antennas in Embodiment 1, Comparative Example 1, and Comparative Example 2 at different frequencies. VV and HH respectively represent amplitude directions of an antenna radiation electric field being a vertical direction and a horizontal direction. An antenna gain test is performed by using a comparison method. Receive power of a standard antenna (with a known gain) and receive power of a to-be-tested antenna are measured separately in a same environment. A difference calculated between the receive power of the standard antenna and the receive power of the to-be-tested antenna plus the gain of the standard antenna is a gain of the to-be-tested antenna.

TABLE 1

| | | VV vertical | HH horizontal |
|---|---|---|---|
| | Frequency | polarization | polarization |
| | (GHz) | gain (dB) | gain (dB) |
| Comparative | 14.4 | 36.28 | 36.41 |
| Example 1 | 14.875 | 36.76 | 37.03 |
| | 15.35 | 36.97 | 37.23 |
| Comparative | 14.4 | 36.78 | 36.91 |
| Example 2 | 14.875 | 37.32 | 37.55 |
| | 15.35 | 37.38 | 37.56 |
| Embodiment 1 | 14.4 | 36.79 | 36.90 |
| | 14.875 | 37.29 | 37.52 |
| | 15.35 | 37.39 | 37.54 |

It can be learned from Table 1 that the antenna that uses the metal bracket as the support structure for the secondary reflective surface in Comparative Example 1 has polarization gains in the vertical direction and the horizontal direction both lower than those in Embodiment 1 and Comparative Example 2. The antenna in Embodiment 1 and the antenna in Comparative Example 2 that use the support connectors containing the foamed materials as the support structures for the secondary reflective surfaces have essentially identical gains, where the polarization gains in the vertical direction and the horizontal direction are increased by about 0.5 dB compared with those in Comparative Example 1.

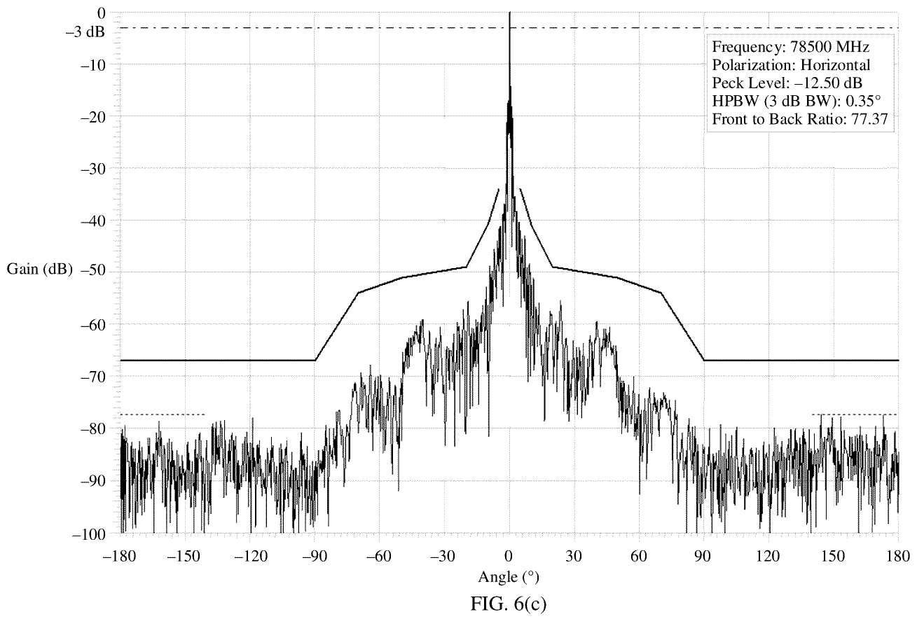

Moreover, FIG. 6(a), FIG. 6(b), and FIG. 6(c) summarize antenna patterns that are of the antenna in Comparative Example 1 (a), the antenna in Comparative Example 2 (b), and the antenna in Embodiment 1 (c) and that are measured in a horizontal polarization direction at a frequency of 78.5 GHZ. In this figure, a polyline is the ETSI Class3 standard template, and the antenna pattern has to be below the polyline to meet the standard requirements. It can be learned from FIG. 6(a), FIG. 6(b), and FIG. 6(c) that, as shown in FIG. 6(a), the antenna pattern of Comparative Example 1 exhibits poor performance in a ±15° range. It indicates that the metal bracket has large impact on near-in sidelobes of the antenna pattern, leaving almost no margin relative to the standard requirements, or even slightly exceeding the standard at some positions. However, the antenna pattern of Embodiment 1 and the antenna pattern of Comparative Example 2 exhibit greatly improved performance in the ±15° range, and both leave a margin of about 5 dB, meeting margin requirements of ETSI C3.

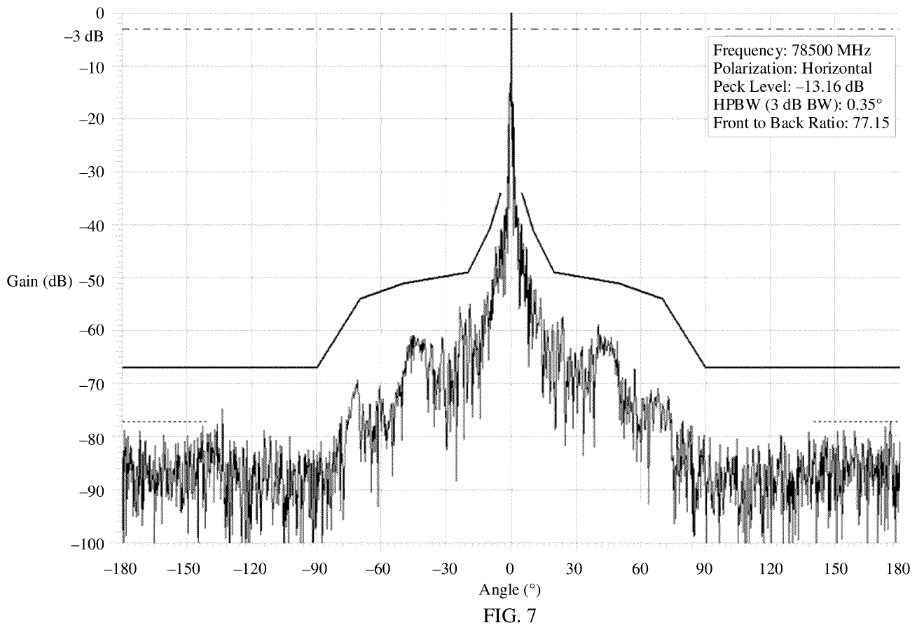

Next, antenna performance of the antenna in Embodiment 1 before a damp heat test and antenna performance of the antenna in Embodiment 1 after the damp heat test are compared. Antenna polarization gains before and after the damp heat test are summarized in Table 2. FIG. 7 shows an antenna pattern that is of the antenna in Embodiment 1 after the damp heat test and that is measured in a horizontal polarization direction at a frequency of 78.5 GHz. In the damp heat test, the antenna is placed in an environment with a temperature of 85° C. and relative humidity of 85% for one week.

TABLE 2

| | Frequency | VV vertical |
|---|---|---|
| | (GHz) | polarization gain (dB) |
| Before the | 71 | 49.38 |
| damp heat test | 78.5 | 50.2 |
| | 86 | 50.67 |
| After one week | 71 | 49.2 |
| of the damp | 78.5 | 50.1 |
| heat test | 86 | 50.5 |
| Pull up by | 71 | 49.73 |
| 1 mm to 2 mm | 78.5 | 50.67 |
| | 86 | 51.24 |

Note: In Table 2, after the support connector 20 in embodiments of this disclosure is placed under hygrothermal conditions for one week, the support connector 20 exhibits slight size shrinkage. “Pull up by 1 mm to 2 mm” means that in the antenna after the damp heat test, the secondary reflective surface 22 in FIG. 2 is moved by 1 mm to 2 mm in a direction away from the feed tube 21, for the secondary reflective surface 22 to be re-accommodated in an upper end opening of the support connector.

It can be learned from Table 2 that, after one week of the damp heat test on the antenna in Embodiment 1, the vertical polarization gain of the antenna at a high frequency decreases only by about 0.1 dB to 0.2 dB, indicating that the impact is negligible. In addition, after refocusing, a gain at each frequency can essentially reach a level comparable to or even superior to that before the damp heat test.

It can be learned from comparison between FIG. 7 and FIG. 6(c) that, the antenna patterns that are of the antenna in Embodiment 1 and that are measured in the horizontal polarization direction before and after the damp heat test show high consistency with no significant difference before and after the test. This indicates that the support material for the secondary reflective surface of the antenna has good weather resistance, avoiding performance degradation due to an operating environment.

The foregoing descriptions are merely example implementations of this disclosure, and the descriptions thereof are specific and detailed, but cannot therefore be understood as a limitation on the scope of this disclosure. It should be noted that a person of ordinary skill in the art may make some variants and improvements without departing from the concept of this disclosure, and the variants and improvements shall fall within the protection scope of this disclosure. Therefore, the protection scope of this disclosure shall be subject to the appended claims.

It should be understood that, in this disclosure, the words “first”, “second”, and the like are merely intended for a purpose of description, and shall not be construed as indicating or implying relative importance or implicitly indicating a quantity of indicated technical features. In addition, in this specification, orientation terms such as “upper” and “lower” are defined relative to orientations of structures in the accompanying drawings. It should be understood that these orientation terms are relative concepts for relative description and clarification, and may correspondingly change according to changes in the orientations of the structures.

In the descriptions of this disclosure, unless otherwise specified, “a plurality of” means two or more. “At least one of the following items (pieces)” or a similar expression thereof means any combination of these items, including a singular item (piece) or any combination of plural items (pieces). For example, “at least one of a, b, or c” or “at least one of a, b, and c” may indicate: a, b, c, a-b (namely, a and b), a-c, b-c, or a-b-c, where a, b, and c may be singular or plural.

In this disclosure, “and/or” describes an association relationship between associated objects, and indicates that three relationships may exist. For example, A and/or B may indicate that: only A exists, both A and B exist, and only B exists, where A and B may be singular or plural. The character “/” usually indicates an “or” relationship between the associated objects.

1. A support connector for an antenna, comprising:
a first end configured to be connected to a feed tube,
a second end configured to be connected to a secondary reflective surface of the antenna,
wherein the support connector is hollow,
wherein the support connector is made of a foamed material, and
wherein a size shrinkage rate of the support connector is less than or equal to 1% after the support connector is placed in an environment with a temperature of 70° C. to 100° C. and relative humidity of 50% to 95% for four days.

2. The support connector according to claim 1, wherein the foamed material comprises a dielectric constant less than or equal to 1.2 at a frequency of 6 GHz to 86 GHz.

3. The support structure according to claim 1, wherein the foamed material comprises a dielectric loss less than or equal to 0.005 at the frequency of 6 GHz to 86 GHz.

4. The support connector according to claim 1, wherein Shore hardness C of the support connector is greater than or equal to 50.

5. The support connector according to claim 1, further comprising an inner surface or an outer surface, wherein a quantity of exposed cells is less than or equal to 20 in any region of at least 2 cm² on the inner surface or the outer surface of the support connector.

6. The support connector according to claim 5, wherein the quantity of exposed cells is less than or equal to 5 in any region of at least 2 cm² on the inner surface and the outer surface of the support connector.

7. The support connector according to claim 1, wherein a percentage of closed cells in the support connector is greater than or equal to 90%.

8. The support connector according to claim 1, wherein a density of the support connector is 0.5 g/cm³ or less.

9. The support connector according to claim 8, wherein the density of the support connector ranges from 0.08 g/cm³ to 0.15 g/cm³.

10. The support connector according to claim 1, wherein transmittance of the support connector is greater than or equal to 90% with a wall thickness of 10 mm or less for a vertically incident microwave in a frequency range of 6 GHz to 86 GHz.

11. The support connector according to claim 1, wherein a glass transition temperature of the support connector is greater than or equal to 150° C.

12. The support connector according to claim 1, wherein the glass transition temperature of the support connector is greater than or equal to 190° C.

13. The support connector according to claim 1, wherein the foamed material comprises a polymer with a main chain containing an aromatic structure.

14. The support connector according to claim 13, wherein the polymer comprises one or more of polyimide, polyether sulfone, polyarylether, and polyarylene sulfide with the main chain containing the aromatic structure.

15. The support connector according to claim 1, further comprising an opening having a size which increases in a gradient from first end to the second end, and further comprises a side smooth and curved surface.

16. The support connector according to claim 1, further comprising a wall thickness between 8 mm to 15 mm.

17. A foamed material, for a support structure for a secondary reflective surface of an antenna, wherein a dielectric constant of the foamed material at a frequency of 6 GHz to 86 GHz is less than or equal to 1.2.

18. The foamed material according to claim 17, further comprising a dielectric loss of less than or equal to 0.005 at the frequency of 6 GHz to 86 GHz.

19. The foamed material according to claim 17, wherein Shore hardness C of the foamed material is greater than or equal to 50.

20. The foamed material according to claim 17, wherein a density of the foamed material is 0.5 g/cm³ or less.

21. An antenna component, comprising:
a secondary reflective surface,
a feed tube,
a hollow support connector having a first end and a second end,
wherein the support structure is configured to be connected between the feed tube and the secondary reflective surface,
wherein the support connector is made of a foamed material,
wherein a size shrinkage rate of the support connector is less than or equal to 1% after the support connector is placed in an environment with a temperature of 70° C. to 100° C. and relative humidity of 50% to 95% for four days, and
wherein the feed tube is connected at the first end, and the secondary reflective surface is connected as the second end.

22. The antenna component according to claim 21, wherein the first end is sleeved on an outer side of the feed tube.

23. The antenna component according to claim 21, wherein the first end is bonded to the feed tube, and the second end is bonded to the secondary reflective surface.

24. The antenna component according to claim 21, wherein the hollow support connector comprises a first main body portion and a second main body portion, wherein the first main body portion is proximate the feed tube, an opening size of the first main body portion is unchanged, and an opening size of the second main body portion gradually increases in a direction toward the secondary reflective surface.

25. An antenna, comprising:
a primary reflective surface,
an antenna component,
wherein the antenna component comprises
a secondary reflective surface,
a feed tube, and
a hollow support connector,
wherein the support connector is configured to be connected between the feed tube and the secondary reflective surface,
wherein the support connector is made of a foamed material,
wherein a size shrinkage rate of the support connector is less than or equal to 1% after the support connector is placed in an environment with a temperature of 70° C. to 100° C. and relative humidity of 50% to 95% for four days,
wherein a first end of the support component is connected to the feed tube and an opposing second end of the support component the secondary reflective surface, wherein the feed tube is connected to the primary reflective surface.
